(19) United States
(12) Patent Application Publication
(10) Pub. No.: US 2006/0231356 A1
(43) Pub. Date: Oct. 19, 2006

(54) Brake Shoe and Drum Brake System Incorporating Same

(75) Inventors: Stan Nowak, Bentley (AU); Dorota Kieronska, Balcatta (AU); Vin C. Morley, Balcatta (AU)

Correspondence Address: NOVAK DRUCE DELUCA & QUIGG, LLP, 1300 EYE STREET NW, SUITE 400 EAST TOWER, WASHINGTON, DC, 20005, US

(73) Assignee: Safe Effect Pty Ltd., Balcatta (AU)

(21) Appl. No.: 11/425,562

(22) Filed: Jun. 21, 2006

Related U.S. Application Data
(63) Continuation of application No. 10/380,701, filed on Sep. 15, 2003.

(30) Foreign Application Priority Data
Sep. 18, 2000 (AU) PR 0187

(51) Int. Cl. F16D 69/00

(52) U.S. Cl. 188/261

(57) ABSTRACT

A brake shoe (10) for a drum brake system (40) is provided with a brake lining (12) having a friction surface (14) which faces braking surface (60) of a brake drum (38). The lining (12) is characterized by the provision of one or more grooves (16) extending across the friction surface (14). The shoe (10) may be incorporated in a cooled drum brake system (10) in which cooling is provided by ventilation holes in the drum (38). Cooling may be further enhanced by the provision of ventilation holes (66) in a back plate (46) of the system (40). In an alternate system, cooling is provided by sealing the drum (38) to form a space for holding a volume of oil.

### CROSS-REFERENCE TO RELATED APPLICATIONS

This application is a continuation of copending application Ser. No. 10/380,701 filed Sep. 15, 2003, which is a National Stage Entry of International Application No. PCT/AU01/01 174, filed Sep. 18, 2001, which claims priority from Australian Patent Application No. PR 0187 filed Sep. 18, 2000.

### FIELD OF THE INVENTION

The present invention relates to a brake shoe and a drum brake system incorporating the brake shoe, particularly, but not exclusively, for automobiles.

### BACKGROUND OF THE INVENTION

A conventional drum brake comprises a drum having an inner circumferential surface that acts as a braking surface and two curved brake shoes each provided with a lining of friction material that can be selectively forced against the braking surface. The drum is bolted to a rotating axle while the brake shoes are attached to a back plate that is fixed to an axle housing in which the axle is rotatably retained.

Drum brakes have several deficiencies in comparison with disc brakes. One main deficiency relates to the dissipation of heat. It is known that under high braking conditions drum brakes fade and lose effectiveness because they are unable to dissipate heat at a sufficiently high rate. It is a well known principle that brake components lose their effectiveness when they become saturated with heat. While heat does also build up in a disc brake system, the components of a disc brake system are able to dissipate heat more quickly because, when the vehicle is moving, the components are in direct contact with a stream of air.

A further disadvantage of drum brakes is the relatively high rate of wear, and unequal wear rate of the brake lining. This can, at least in part, be attributed to the inherent configuration of the drum brake which encourages dust (from the brake linings), grit and dirt to accumulate in the drum and subsequently become trapped between the brake lining and the braking surface.

Notwithstanding these disadvantages, drum brakes do have a significant advantage over disc brakes in that they are relatively inexpensive and therefore lead to reduced production costs and vehicle purchase costs. It is for this reason many production cars are manufactured with front disc brakes and rear drum brakes. It is known that between sixty and ninety percent of a vehicle stopping power comes from the front wheels. Therefore, with the exception of high performance production vehicles, the combination of front disc brakes and rear drum brakes is perfectly adequate.

It is an object of the present invention to provide a brake shoe and a drum brake system incorporating said brake shoe that attempt to overcome at least one of the above described disadvantages in the prior art.

### SUMMARY OF THE INVENTION

According to a first aspect of the present invention there is provided a brake shoe for a drum brake system having a drum provided with an inner circumferential braking surface, said brake shoe including at least:

a brake lining provided with a friction surface for selectively engaging said braking surface, said friction surface having a first and second opposite circumferential edges and first and second opposite axial edges extending between said circumferential edges; said brake lining provided with one or more grooves extending between any two of said edges; and,

one or more scraping means supported adjacent said brake lining, each scraping means radially moveable between a first position where said scraping means extends radially beyond said friction surface and a second position where said scraping means is retracted radially to lie substantially flush with said friction surface.

Preferably said brake shoe further includes bias means for biasing said scraping means toward said first position.

Preferably a first of said scraping means is located near one end of said brake lining and extends axially across said brake shoe for a width coterminous with said friction surface.

Preferably a second of scraping means is located near an opposite end of said brake lining and extends axially across said brake shoe for a width coterminous with said friction surface.

Preferably each of said scraping means is spaced from an adjacent end of said brake lining to provide a corresponding gap therebetween.

Preferably each of said scraping means is provided with a contact face for contact with said braking surface.

Preferably each of said scraping means is provided with one or more grooves that extends between any two edges of said contact face.

Preferably said friction surface has first and second opposite circumferential edges and first and second opposite axial edges extending between said circumferential edges.

Preferably said grooves on said friction surface include at least one groove extending between said first and second circumferential edges.

Preferably said grooves on said friction surface include at least one groove extending between said first and second axial edges.

Preferably said grooves on said friction surface include at least one groove that extends from one of said axial edges to one of said circumferential edges.

Preferably said scraping means is made of a resilient material having a low coefficient of friction.

According to a further aspect of the present invention there is provided a drum brake system including at least:

a brake drum for coupling with a rotatable shaft, said drum having an inner circumferential braking surface; and,

a plurality of brake shoes each according to the first aspect of the present invention, said brake shoes adapted for coupling to a stationary plate, and disposed with their respective friction surfaces in facing relationship with said braking surface.

Preferably said drum and brake shoes are juxtaposed so that said scraping means are always in contact with said braking surface.

Preferably said braking system further includes cooling means for cooling said brake drum and said brake shoes.

In one embodiment, said cooling means includes a plurality of ventilation holes formed in an axial end face of said drum. In this embodiment, said cooling means further includes a plurality of ventilation holes formed in said back plate.

In an alternate embodiment, said cooling means includes a volume of a liquid held within said brake drum, and sealing means for sealing said brake drum.

Preferably said sealing means includes:

an annular plate having an outer circumferential region and an inner circumferential region, said annular plate coupled about said outer circumferential region to said brake drum, and coupled about said inner circumferential region to a housing in which said shaft is disposed;

a fixed seal acting between one of said outer circumferential region and said drum; and, said inner circumferential region and said housing; and,

a dynamic seal acting between the other of said outer circumferential region and said brake drum; and, said inner circumferential region and said axle region.

Preferably said fixed seal is disposed between said outer circumferential region and said drum, and said dynamic seal is disposed between said inner circumferential and said housing.

According to the present invention there is further provided a wet drum braking system including at least:

a brake drum for coupling to an end of a rotatable shaft, said brake drum having an inner circumferential braking surface;

a plurality of brake shoes adapted for coupling to a stationary plate, each brake shoe having a brake lining provided with a friction surface in facing relationship to said braking surface, each braking surface provided with one or more grooves extending across its friction surface;

sealing means coupled between said brake drum and a housing in which said end of said shaft is disposed to form a sealed space enclosing said brake shoes and braking surface; and adapted to hold a volume of liquid.

According to a further aspect of the invention there is provided a drum brake system including at least:

a brake drum adapted for coupling to a rotatable shaft, said drum having an inner circumferential braking surface; and

a plurality of brake shoes adapted for coupling to a stationary plate, each brake shoe having a brake lining provided with a friction surface disposed in facing relationship to said braking surface;

and at least one groove formed on each of said braking surface and said friction surface;

wherein said at least one groove formed on said braking surface extends either between opposite circumferential edges of said braking surface; or, circumferentially along said braking surface; and

said at least one groove formed on said friction surface extends between any two edges of said friction surface.

### BRIEF DESCRIPTION OF THE DRAWINGS

Embodiments of the present invention will now be described by way of example only with reference to the accompanying drawings in which:

FIG. 1 is a rear plan view of a brake shoe in accordance with an embodiment of the present invention;

FIG. 1A is an enlarged view of a portion of the brake shoe depicted in FIG. 1 forward of line 1A-1A;

FIG. 2 is a front plan view of the brake shoe depicted in FIG. 1;

FIG. 3 is a side view in partial section of the brake shoe depicted in FIGS. 1 and 2;

FIG. 4 is a view through section 4-4 of a scraper incorporated in the brake shoe depicted in FIG. 1A;

FIG. 5 is a section view of a brake drum incorporated in a brake system in accordance with an embodiment of the present invention in juxtaposition with a conventional prior art axle;

FIG. 6 is a front view of the brake drum depicted in FIG. 5;

FIG. 7 is a section view of a brake drum incorporated in a further embodiment of the present invention;

FIG. 8 is a plan view of the brake drum system depicted in FIG. 7 but with a drum cover removed; and,

FIGS. 9a-9d depict different groove patterns applicable to the brake shoe depicted in FIGS. 1-3.

### DETAILED DESCRIPTION OF PREFERRED EMBODIMENTS

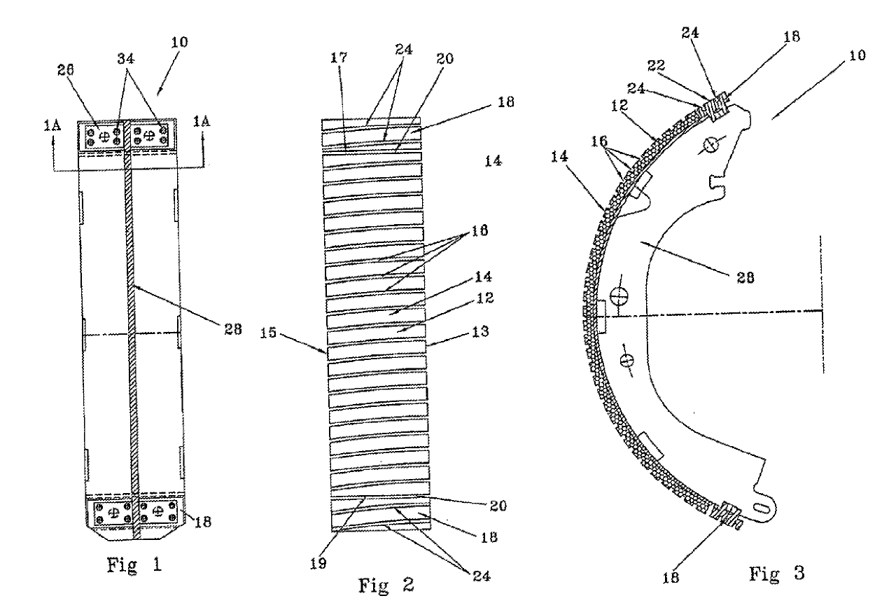

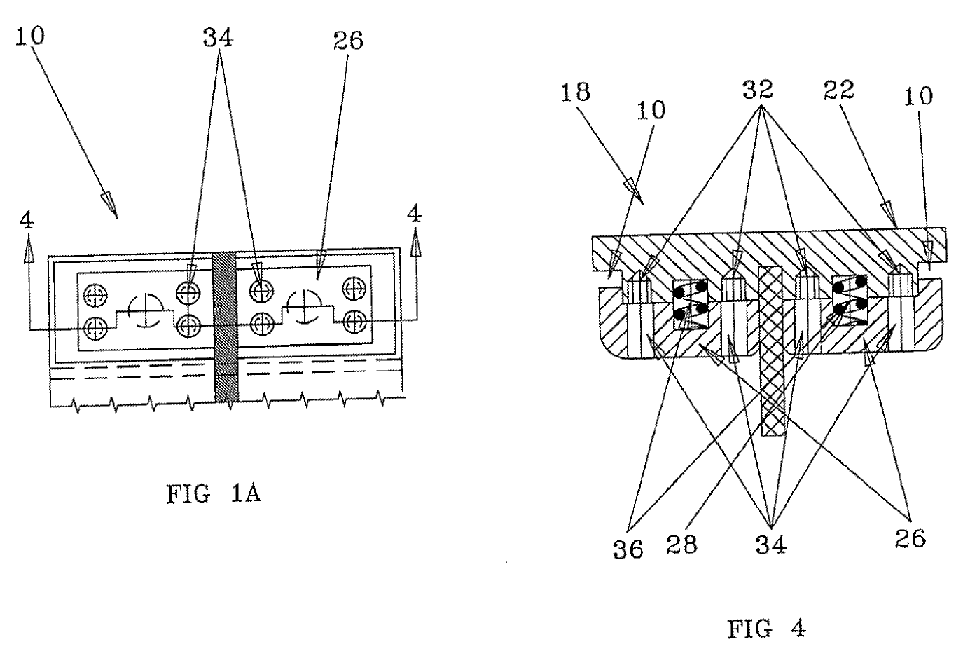

Referring to FIGS. 1-4, a brake shoe 10 for a drum brake system is provided with a brake lining 12 having a friction surface 14, which in use faces the braking surface of a brake drum, with the lining 12 being characterized by the provision of one or more grooves 16 extending across the friction surface 14.

Conventional drum brake systems are not sealed and therefore are subject to the ingress of water, for example when driving in the rain or through puddles. The grooves 16 assist in channeling any water, brake lining dust and other debris away from the region between the brake drum and the friction surface 14 during braking.

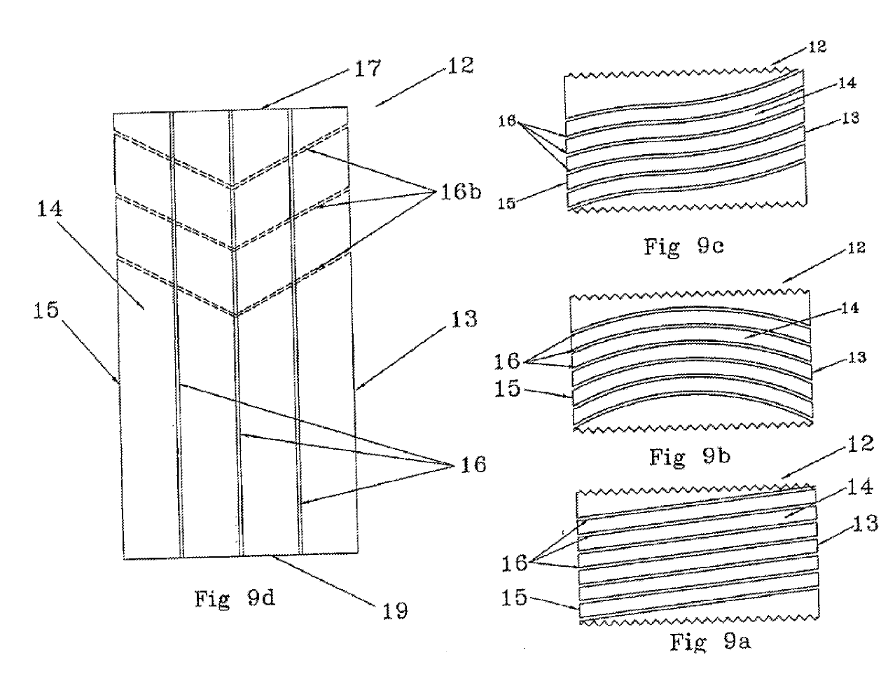

The friction surface 14 has opposite circumferential lateral edges 13 and 15 and opposite axial (leading and trailing) edges 17 and 19 tat extend between the circumferential edges 13 and 15. In the embodiment depicted in FIG. 2, the grooves 16 extend in a transverse or axial direction across the surface 12 from edge 13 to edge 15. Further, the grooves are provided with a slight curvature. However, as depicted in FIGS. 9a-9d, the grooves can take many different configurations.

In FIG. 9a, the grooves 16 are straight and slope downwardly from edge 13 to edge 15. In FIG. 9b, the grooves 16 extend between edges 13 and 15 in the shape of a bow. In FIG. 19c, the grooves 16 are in the form of an inflexion extending from edge 13 to edge 15. FIG. 9d depicts linear grooves 16 extending in the circumferential direction from edge 17 to edge 19 parallel to the edges 13 and 15. Additional inclined grooves 16a (shown in phantom) can also be provided that extend from edges 13 and 15 and are inclined downwardly toward edge 19 converging at a central circumferential groove 16. Further the grooves may follow spiroidal paths between edges 13 and 15.

To further assist in cleaning the braking surface of a brake drum prior to a braking action, the shoe 10 is also provided, in this embodiment, with two scrapers 18. One scraper 18 is provided near each end of the lining 12 and extends across the shoe 10 so as to be coterminous with the lining 12. Each scraper 18 is spaced by short distance from its is respective end of the liner 12 to provide a small gap 20 between the ends of the lining 12 and the scrapers 18.

The scrapers 18 are, when viewed in the use configuration shown in FIG. 3, radially moveable between a first position where the scrapers extend radially beyond the friction surface 14 and a second position where the scrapers 18 are retracted radially to lie substantially flush with the friction surface 14. Ideally, the scrapers 18, and more particularly the shoe 10, is juxtaposed relative to a brake drum so that the scrapers 18 are always in contact braking surface of the drum. In this way, the scrapers 18 continually scrape any dust, dirt or liquid from the braking surface of the drum.

Each scraper 18 has a contact face 22 of the same curvature as lining 12 for face to face contact with the braking surface of the drum. The contact face 22 is also provided with: one or more grooves 24 extending thereacross. The grooves 24 serve the same purpose as grooves 16 on the lining 12.

Mounting blocks 26 are attached to the underside of the shoe 10 opposite the lining 12 for resiliently mounting the scrapers 18. One block 26 is provided on each side of the shoe mounting rib 28 (which is of conventional shape and configuration being provided with various holes and slots for receiving connecting springs, return springs, hydraulic actuator and the like). Eight spaced apart threaded holes 32 are provided on the underside of scrapers 18 opposite the contact face 22. Each of the threaded holes 32 on scrapers 18 are adapted to align with corresponding holes 34 provided in each of the mounting blocks 26. Respective screws (not shown) are connected at one end to the holes 32 in scrapers 18 and have a remaining length slidably retained within the holes 34 of the mounting blocks 26. Biased means in the form of two compression springs 36 have opposite ends retained in respective holes of the scrapers 18 and the mounting blocks 26 respectively to bias the scrapers 18 in the radial direction so as to extend beyond the friction surface 14.

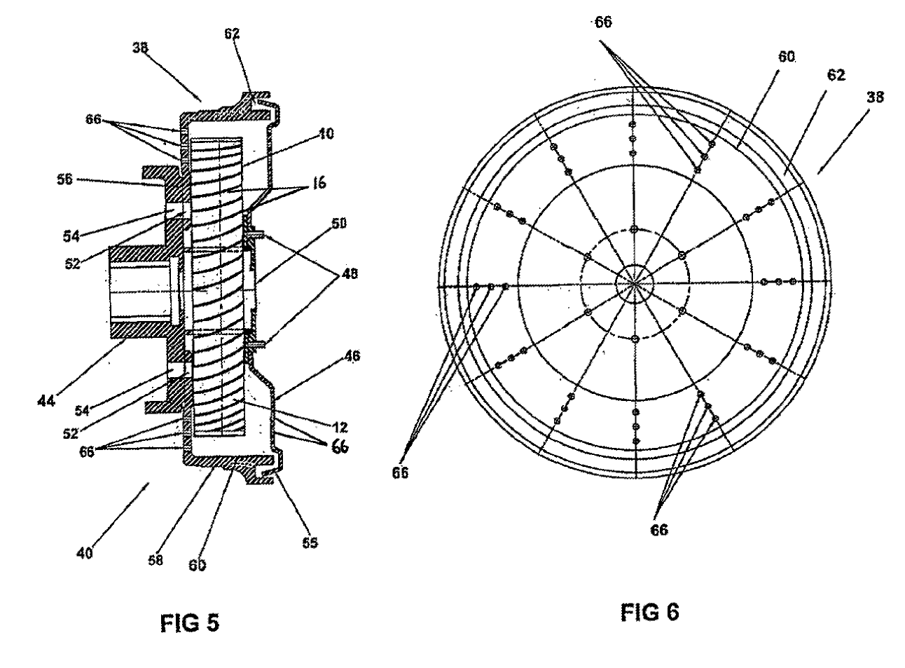

FIG. 5 depicts an embodiment of a modified brake drum 38 which together with the brake shoes 10 forms a brake drum system 40. The drum 38 is shown in juxtaposition with a conventional hub 44 and back plate 46. The back plate 46 is fixed to a differential housing (not shown) by studs 48. A rotatable axle shaft (not shown) is housed in the differential housing and extends through central opening 50 in the back plate 46 for coupling to the drum 38 and hub 44 in a conventional manner, e.g. by wheel studs (not shown) passing through holes 52 and 54 formed in the drum 38 and hub 44 respectively. The back plate 46 is formed with a contiguous inwardly turned lip 55, and supports the brake shoes 10 and other components of the braking system such as the wheel cylinder (not shown). The brake drum 38 includes an end plate 56 provided with the holes 52 for receiving the wheel studs (not shown), and an axially extending circumferential skirt 58. The inside surface of the skirt 58 forms a circumferential braking surface 60 against which the brake linings 12 of shoes 10 are pressed during a braking action. The free end of the skirt 58 is provided with an annular groove 62 for seating, with clearance, the lip 55.

The above described features of the drum 38 and system 40 are common with conventional brake drums. The drum 38 however differs from a conventional brake drum by the provision of a plurality of through holes 66 formed in the end plate 54. The holes 66 constitute ventilation holes for ventilating the inside of the drum 38 thereby cooling the components of the brake system including the shoes 10 and the braking surface 60. Cooling can be further enhanced by the provision of further ventilation holes 66 in the back plate 52. Thus, one form of a drum brake system 40 in accordance with the present invention includes brake shoes 10 as depicted in FIGS. 1-4 together with a brake drum 38 as depicted in FIG. 5. Of course, as should be readily apparent, the shoes 10 can also be incorporated in a standard drum brake system, i.e. one with a drum 38 and back plate do not include ventilation holes 66.

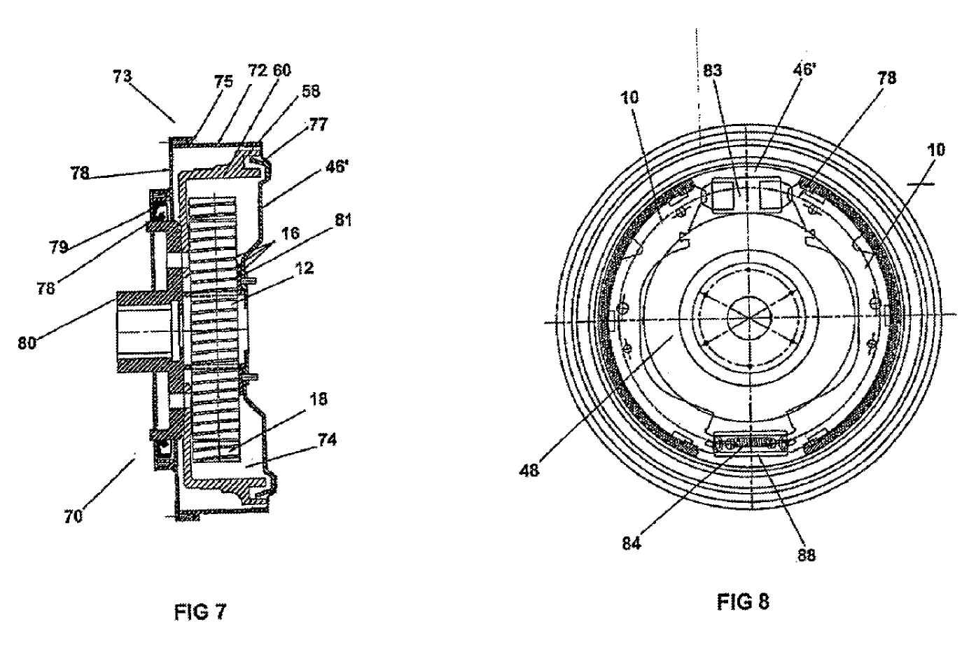

FIGS. 7 and 8 depict a further embodiment of the braking system 70 in accordance with the present invention. The system 70 includes two brake shoes 10 as depicted in FIGS. 1-4 together with a modified drum 38′ and sealing means which includes a sealing cover 72 defining a sealed space 74 for holding a supply of liquid such as oil and in which the shoes 10 and braking surface 60 are disposed. The drum 38′ differs from drum 38 by omission of ventilation holes 66. The cover 72 incorporates at its back side back plate 46′, which is similar to back plate 52 but without ventilation holes 66. The cover 72 also includes a front casing 73 which is composed of a circumferential band 75 extending in the axial direction and an annular plate 76 extending radially inwardly from a front end of the band 75. The band 75 is coupled by bracket 77 to the back plate 46′, typically by welding. A seal housing 78 is attached to the plate 76 and houses a dynamic seal 79 which forms a fluid seal against an axial flange 80 of a hub 44. A static sealing gasket 81 is provided about a circumferentially arranged studs 48 used for mounting the back plate 46′ to the differential housing.

The oil held within the sealed space 74 acts to reduce heat build up by aiding in heat dissipation and also minimizes wear of the brake shoe lining 12 and braking surface 60. The cooling effect of the oil may be enhanced by feeding the oil held within the space 74 though an external radiator. This can be achieved by plumbing intake and return conduits through the diff housing into the space 74 for passing the oil through a radiator and returning it to the space 74.

In FIG. 8, the braking system 70 is depicted with the drum 38′ removed. This shows the shoes 10 attached to the backing plate 46′ and coupled at an upper end to a wheel cylinder 83 and an opposite end by connecting spring 84 and an adjustment mechanism 86. The shoes 10 are operated and move in the same manner as a conventional drum brake system.

However the scrapers 18 act to scrape oil from the braking surface 20 as the drum 38′ rotates. This occurs when the friction surface 14 of the shoes 10 are not in contact with the braking surface 60. When the brakes are applied, the friction surfaces 14 are pressed against the braking surface 60. Oil disposed between the braking surface 60 and the friction surface 14 is channeled away through spiroidal grooves 16, in a manner similar to the way in which the tread of a tire removes water from a wet road surface.

The provision of the oil within the drum brake system 70 acts to both cool the components of the drum brake system as well as minimize wear of the linings 12.

Now that embodiments of the present invention have been described in detail it will be apparent to those skilled in the relevant arts that various modifications and variations may be made without departing from the basic inventive concepts. For example, the system 70 depicted in FIGS. 7 and 8 depicts the use of two brake shoes 10. However, in an alternate form, three or more brake shoes can be used in place of the two shoes depicted. This however will require modification to the back plate 46, 46′ and the operational mechanism for operating the brake. Further, with reference to FIG. 7, in vehicles in which a separate hub 44 is not provided or required, the drum 38 can be sealed at its front end by a circular plate which can be bolted to the drum 38 via the wheel mounting studs (not shown) that would pass through stud holes 52 and, a ring-like flange extending integrally and axially from the plate (in a similar manner to flange 80 in the hub 44) or alternately welded or otherwise attached directly onto the drum 38 to act as a sealing surface for the dynamic seal 79. Additionally the braking surface 60 of the drum 38 can be provided with grooves 61 in addition to or instead of the grooves 16 on the friction surface 14, as shown in FIG. 7. The grooves, if provided on the braking surface, can be formed as extending between opposite circumferential (lateral) edges of the braking surface or circumferentially about the braking surface. Of course there can be a combination of both.

All such modifications and variations are deemed to be within the scope of the present invention the nature of which is to be determined from the above description, and the appended claims.

What is claimed is:

1. A drum brake system comprising:
a brake drum adapted for coupling to a rotatable shaft, said drum having an inner circumferential braking surface; and a plurality of brake shoes adapted for coupling to a stationary plate, each brake shoe having a brake lining provided with a friction surface disposed in facing relationship to said braking surface; and
at least one groove formed on each of said braking surface and said friction surface; wherein said at least one groove formed on said braking surface extends either between opposite circumferential edges of said braking surface; or, circumferentially along said braking surface; and
said at least one groove formed on said friction surface extends between any two edges of said friction surface; wherein the grooves on at least one of the braking surface and the friction surface comprise spaced apart side walls that extend inwardly from the respective surface in which the groove is formed, said grooves being configured so that when the friction surface contacts the braking surface, the side walls of the grooves on said at least one of the braking surface and the friction surface are spaced apart from the grooves on the other of the friction surface and the braking surface, respectively.

2. A drum brake system according to claim 1, further including cooling means for cooling said brake drum and said brake shoes.
